(19) United States
(12) Patent Application Publication
(10) Pub. No.: US 2015/0062466 A1
(43) Pub. Date: Mar. 5, 2015

(54) DISPLAY DEVICE

(71) Applicant: SAMSUNG DISPLAY CO., LTD., Yongin-City (KR)

(72) Inventor: Yeo-Jin YUN, Yongin-City (KR)

(21) Appl. No.: 14/471,312

(22) Filed: Aug. 28, 2014

(30) Foreign Application Priority Data
Aug. 29, 2013 (KR) 10-2013-0102940

(51) Int. Cl. G06F 1/16

(52) U.S. Cl. CPC G06F 1/1601; G06F 1/169
USPC 349/12

(57) ABSTRACT

A display device includes a display module, a driving circuit unit, a window, a first flexible circuit board, and a shielding unit. The driving circuit unit may supply a driving signal to the display module. The window may be positioned on the display module. The first flexible circuit board may have a touch sensor at one end portion thereof, the one end portion being attached to the window. The shielding unit may extend to protrude toward the driving circuit unit from the one end portion of the first flexible circuit board to shield the driving circuit unit.

### CROSS-REFERENCE TO RELATED APPLICATION

Korean Patent Application No. 10-2013-0102940, filed on Aug. 29, 2013, in the Korean Intellectual Property Office, and entitled: “Display Device,” is incorporated by reference herein in its entirety.

### BACKGROUND

1. Field

The present disclosure relates to a display device and components for the same.

2. Description of the Related Art

As interest in information display devices and demand for portable information media increases, research and commercialization on light, thin film type flat panel display devices (FPD devices) replacing cathode ray tubes (CRTs) that are existing display devices is actively being conducted. Particularly, among these FPD devices, a liquid crystal display (LCD) device is a device which displays an image using optical anisotropy of liquid crystals. The LCD device is actively being applied to notebook computers, desktop monitors or the like because it has an excellent resolution, color rendering capability and picture quality. An organic light emitting display (OLED) device displays images using organic light emitting diodes that emit light through recombination of electrons and holes. The organic light emitting display device has a fast response speed and is driven with low power consumption. Thus, the OLED device has been actively applied.

### SUMMARY

According to an aspect of the present disclosure, there is provided a display device including a display module, a driving circuit unit, a window positioned on the display module, a first flexible circuit board, and a shielding unit. The driving circuit unit may supply a driving signal to the display module. The first flexible circuit board may be configured to have a touch sensor at one end portion thereof, wherein the one end portion is attached to the window. The shielding unit may extend to protrude toward the driving circuit unit from the one end portion of the first flexible circuit board, to shield the driving circuit unit.

The shielding unit may cover a side surface of the driving circuit unit.

The shielding unit may have a quadrangular box shape having an opened bottom surface or opened top and bottom surfaces.

The shielding unit may include a material having conductivity.

The shielding unit may be electrically coupled to a ground terminal of the first flexible circuit board.

One side of the shielding unit may be coupled to the first flexible circuit board, and the other side of the shielding unit may be adjacent to the display module on which the driving circuit unit is positioned.

The one end portion of the first flexible circuit board may have first and second surfaces opposite to each other. The touch sensor may be positioned on the first surface, and the shielding unit may be extended from the second surface.

The driving circuit unit may be positioned in a non-display area of the display module.

The touch sensor may be provided at a position corresponding to the non-display area of the display module.

The display module may include a first substrate, and a second substrate positioned opposite to the first substrate, the second substrate being positioned more distant from the window than the first substrate, and the second substrate may be wider than the first substrate and include a protruding area. The driving circuit unit may be positioned on the protruding area.

The display may further include a second flexible circuit board configured to have one end portion electrically coupled to the driving circuit unit.

The second flexible circuit board may be bent to surround a side of the display module, so that the other end portion opposite to the one end portion of the second flexible circuit board is positioned on an opposite surface of the display module to a surface on which the driving circuit unit is positioned.

The first flexible circuit board may be bent so that the other end portion opposite to the one end portion of the first flexible circuit board is coupled to the other end portion of the second flexible circuit board.

### BRIEF DESCRIPTION OF THE DRAWINGS

Features will become apparent to those of ordinary skill in the art by describing in detail exemplary embodiments with reference to the attached drawings.

Example embodiments are described herein with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 illustrates a sectional view showing a portion of a display device according to an embodiment of the present disclosure.

FIG. 2 illustrates a plan view of a display device module in the display device shown in FIG. 1.

FIG. 3 illustrates a perspective view of one end portion of a first flexible circuit board in the display device shown in FIG. 1.

FIG. 4 illustrates a perspective view of a shielding unit in the display device shown in FIG. 1.

FIG. 5 illustrates a perspective view showing a state in which the one end portion of the first flexible circuit board shown in FIG. 3 is coupled to the shielding unit shown in FIG. 4.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. In addition, it will also be understood that when a layer is referred to as being “between” two layers, it can be the only layer between the two layers, or one or more intervening layers may also be present. Like reference numerals refer to like elements throughout. When a first element is described as being coupled to a second element, the first element may be not only directly coupled to the second element but may also be indirectly coupled to the second element via a third element.

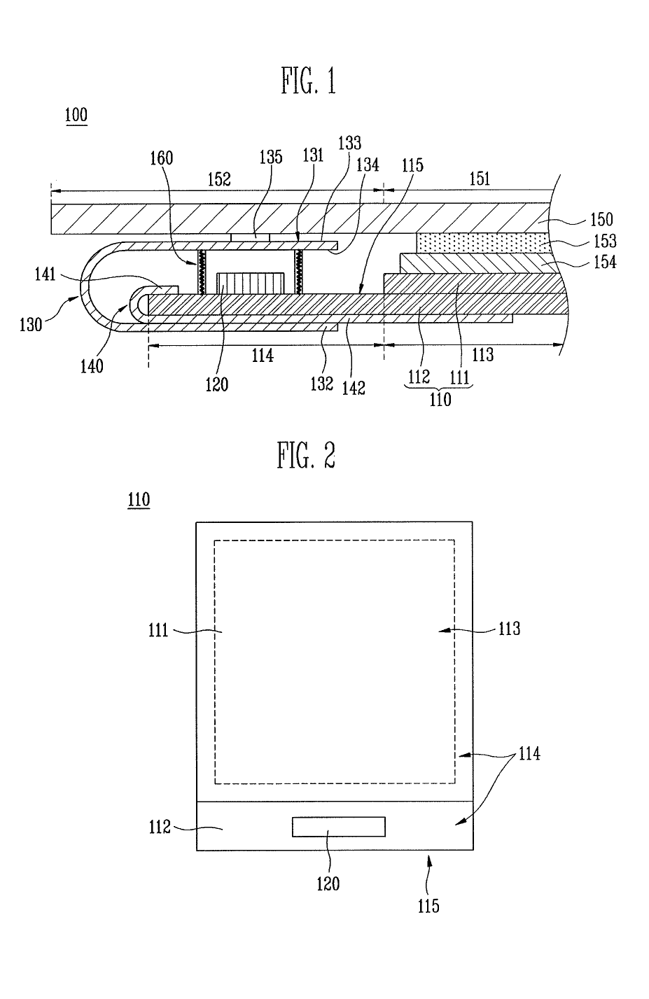

FIG. 1 illustrates a sectional view showing a portion of a display device 100 according to an embodiment of the present disclosure. FIG. 2 illustrates a plan view of a display module 110 in the display device 100 shown in FIG. 1. Hereinafter, the display device 100 according to this embodiment will be described with reference to FIGS. 1 and 2.

As shown in FIGS. 1 and 2, the display device 100 according to this embodiment includes a display module 110, a window 150, a first flexible circuit board 130 and a shielding unit 160. The shielding unit 160 may cover a driving circuit unit 120 to shield the driving circuit unit 120 from EMI/ESD.

The display module 110 is a member that displays an image. The display module 110 may include a display area 113 in which the image is displayed, and a non-display area 114 in which the image is not displayed.

Here, a plurality of pixels is formed in the display area 113 to display an image, and the image need not be displayed in the non-display area 114. The display module 110 may be an organic light emitting display module including an organic light emitting element or a liquid crystal display module including a liquid crystal layer, or the like. In this case, the plurality of pixels is provided between first and second substrates 111 and 112 opposite to each other, so that the image can be displayed in the display area 113.

Meanwhile, the first and second substrates 111 and 112 may be insulative substrates made of glass, quartz, ceramic, plastic or the like. The first substrate 110 may be an encapsulation substrate that is more adjacent to the window 150 than the second substrate 112, and the second substrate 112 may be a low temperature polycrystalline silicon (LTPS) substrate that is formed wider than the first substrate 111 to have a protruding area 115. In this case, the protruding area 115 may be a portion of the non-display area 114, and the driving circuit unit 120 may be positioned on the protruding area 115.

The driving circuit unit 120 is a member that supplies a driving signal to the display module 110. The driving circuit module 120 may be provided to the display module 110. For example, the driving circuit unit 120 may be positioned on the protruding area 115 of the second substrate 112 in the non-display area 114 of the display module 110, and accordingly, the first substrate 111 can be positioned at a side of the driving circuit unit 120 in a state in which the first substrate 111 is opposite to the second substrate 112. Meanwhile, the driving circuit unit 120 may be electrically coupled to a second flexible circuit board 140 and the display module 110. The driving circuit unit 120 may receive a control signal provided through the second flexible circuit board 140 to supply various signals a data or gate line of the display module 110, in response to the received control signal.

In this case, the second flexible circuit board 140 may have a bend shape to surround a side of the second substrate 112. One end portion 141 of the second flexible circuit board 140 may face a direction adjacent to the driving circuit unit 120 so as to be electrically coupled to the driving circuit unit 120, and the other end portion 142 of the second flexible circuit board 140 may be positioned on the other surface of the second substrate 112, opposite to one surface of the second substrate 112. The second flexible circuit board 140 may be electrically coupled directly to the driving circuit unit 120, or may be electrically coupled to the driving circuit unit 120 through a circuit pattern formed on the second substrate 112.

The window 150 is a member positioned on the display module 110. The window 150 protects the display module 110, the driving circuit unit 120, the first flexible circuit board 130, and the like from the outside of the display device 100.

Here, a window display area 151 of the window 150, corresponding to the display area 113 of the display module 110 may be implemented transparent or translucent so that a user can see an image displayed by the display module 110. A printing layer is provided in a window non-display area 152 of the window 150, corresponding to the non-display area 114 of the display module 110, so that internal electronic components including the driving circuit unit 120, the flexible circuit boards 130 and 140, and the like cannot be seen by the user. Meanwhile, the window 150 may be adhered to the display module 110 through a transparent adhesive layer 153. In this case, a polarizing plate 154 may be interposed between the transparent adhesive layer 153 and the display module 110. The size of the transparent adhesive layer 153 or the polarizing plate 154 may be formed identical to or smaller than that of the first substrate 111 narrower than the second substrate 112. Therefore, the transparent adhesive layer 153 and the polarizing plate 154 need not be positioned above the driving circuit unit 120 on the second substrate 112. Thus, the window 150 can be positioned above the driving circuit unit 120 in a state in which the window 150 is spaced apart from the driving circuit unit 120, and one end portion 131 of the first flexible circuit board 130 can enter into a space between the driving circuit unit 120 and the window 150.

The first flexible circuit board 130 is a member that has a touch sensor 135 at the one end portion 131 to transmit/receive an electrical signal to/from the touch sensor 135. The one end portion 131 of the first flexible circuit board 130 may be attached to a bottom surface of the window 150.

The first flexible circuit board 130 may have first and second surfaces 133 and 134 opposite to each other, and the touch sensor 135 may be electrically coupled to the first surface 133 of the one end portion 131 of the first flexible circuit board 130. Therefore, the second surface 134 of the one end portion 131 of the first flexible circuit board 130 may be in a state in which the second surface 134 faces the driving circuit unit 120 exposed below the window 150 and a top surface of the second substrate 112. The touch sensor 135 may be in a state in which the touch sensor 135 is attached to or spaced apart from the bottom surface of the window 150. When the user touches the window non-display area 152 of the window 150, corresponding to the position of the touch sensor 135, the touch sensor 135 can sense the touched position and transmit an electrical signal to the first flexible circuit board 130. In this case, the position of the touch sensor 135 may be a position corresponding to the non-display area 114 of the display module 110. The touch sensor 135 may be implemented as, for example, a capacitive touch sensor. The touch sensor 135 may be configured with a plurality of touch sensors to provide several touch buttons. The touch sensor 135 may have a light emission portion such as an LED so that the user can detect a portion to be touched while viewing the window 150. In this case, the first flexible circuit board 130 may include the touch sensor 135, and hence a driving circuit unit for controlling the touch sensor 135 may be separately provided. Alternatively, the touch sensor 135 may be controlled using the driving circuit unit 120 of the display module 110.

Like the second flexible circuit board 140, the first flexible circuit board 130 may have a bent shape to surround a side of the display module 110, and the other end portion 132 of the first flexible circuit board 130 may be positioned adjacent to the other end portion 142 of the second flexible circuit board 140 so as to be electrically coupled to the other end portion 142 of the second flexible circuit board 140. Thus, the display device 100 can have a shape in which the other end portion 142 of the second flexible circuit board 140 and the other end portion 132 of the first flexible circuit board 130 are sequentially coupled to the bottom surface of the second substrate 112. In addition, a member such as a chassis can be provided beneath the shape to protect the first and second flexible circuit boards 130 and 140.

The driving circuit unit 120 may be exposed in the display having the structure described above. Therefore, if ESD is flowed in the display device 100 from the outside of the display device 100, the driving circuit unit 120 may be damaged. If EMI of the driving circuit unit 120 is discharged to the outside of the display device 100, another component of the display device 100 may be influenced by the EMI. In order to solve such a problem, the display device 100 according to this embodiment may further include the shielding unit 160.

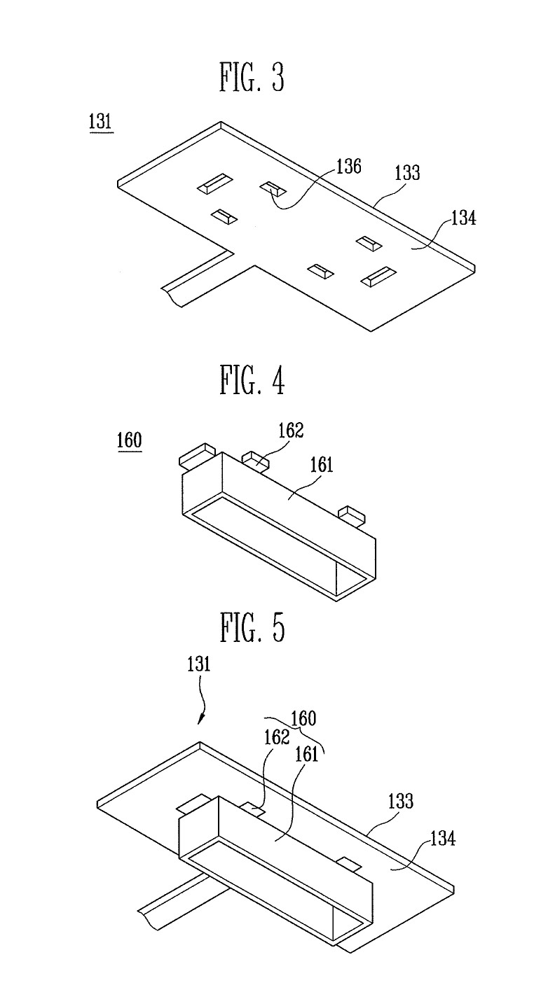

FIG. 3 illustrates a perspective view of the one end portion 131 of the first flexible circuit board 130 in the display device 100 shown in FIG. 1. FIG. 4 illustrates a perspective view of the shielding unit 160 in the display device 100 shown in FIG. 1. FIG. 5 illustrates a perspective view showing a state in which the one end portion 131 of the first flexible circuit board 130 shown in FIG. 3 is coupled to the shielding unit 160 shown in FIG. 4. Hereinafter, the shielding unit according to this embodiment will be described with reference to FIGS. 1 and 3 to 5.

The shielding unit 160 is a member that covers the driving circuit unit 120 by being protruded toward the driving circuit unit 120 from the second surface 134 of the one end portion 131 of the first flexible circuit board 130. The shielding unit 160 may have, for example, a quadrangular box shape having opened top and bottom surfaces as shown in FIG. 4, and one side of the shielding unit 160 may be coupled to the one end portion 131 of the first flexible circuit board 130 so that the top surface of the shielding unit 160 can be blocked by the one end portion 131 of the first flexible circuit board 130. In this case, the shielding unit 160 does not necessarily have the shape shown in FIG. 4. For example, the bottom surface of the shielding unit 160 may be opened without opening other portions so that the driving circuit unit 120 can inserted into the shielding unit 160 through the bottom surface of the shielding unit 160. In addition, the shielding unit 160 may have the shape of a circular box, a triangular box or the like.

The other side of the shielding unit 160, opposite to one side coupled to the one end portion 130 of the first flexible circuit board 130, may be coupled or adjacent to the top surface of the second substrate 112 of the display module 110 on which the driving circuit unit 120 is positioned. Accordingly, it is possible to prevent the driving circuit unit 120 from being exposed to the outside. In a case where the other side of the shielding unit 160 is coupled to the top surface of the second substrate 112, the circuit pattern of the second substrate 112 through which the second flexible circuit board 140 is coupled to the driving circuit unit 120 may be positioned at the other lower portion of the shielding unit 160.

The shielding unit 160 may include a conductive material such as metal. The shielding unit 160 may include a main body portion 161 configured to form a sidewall substantially vertical to the second surface 134 of the one end portion 131 of the first flexible circuit board 130, and a protruding portion 162 extended to protrude from the main body 161. In this case, the protruding portion 162 may be bent to be substantially parallel to the second surface 134 of the one end portion 131 of the first flexible circuit board 130.

The one end portion 131 of the first flexible circuit board 130 may be implemented wider than another area so that the shielding unit 160 that covers the driving circuit unit 120 can be sufficiently positioned. One or more ground terminals 136 may be provided in the second surface 134 of the one end portion 131 of the first flexible circuit board 130. For example, the ground terminal 136 may be implemented by cutting a coverlay positioned at the outermost side of the first flexible circuit board 130 and exposing a conduction wire inside the coverlay. In this case, the protruding portion 162 of the shielding unit 160 may be provided with one or more protruding portions to be electrically coupled to the respective ground terminals 136, and accordingly, the shielding unit 160 can maintain a grounded state.

According to this embodiment, the shielding unit 160 in the grounded state may shield the side surface of the driving circuit 120, and the first flexible circuit board 130 may shield the top surface of the driving circuit unit 120. Alternatively, the shielding unit 160 in the grounded state may shield the side and top surfaces of the driving circuit unit 120. Thus, the driving circuit unit 120 can be shielded from ESD/EMI. For example, although ESD/EMI generated from an outside of the display device 100 or an internal component of the display device 100 faces the driving circuit unit 120, the generated ESD/EMI is induced to the ground terminal 136 by the shielding unit 160, and accordingly, it is possible to prevent the driving circuit unit 120 from being damaged or erroneously operated. Further, ESD/EMI generated from the driving circuit unit 120 is induced to the ground terminal 136 by the shielding unit 160, and accordingly, it is possible to prevent the internal component of the display device 100 from being damaged or erroneously operated by the ESD/EMI generated from the driving circuit unit 120. Thus, the display device 100 can be stably driven, and it is possible to reduce cost spent in replacing a damaged component, and the like.

By way of summation and review, when a display device is used, ESD/EMI generated from an outside of the display device or an internal component of the display device also has influence on other internal components, and therefore, the internal components may be damaged or erroneously operated. According to the display device of the present disclosure, the driving circuit unit is shielded using the shielding unit extended from the first flexible circuit board, and it is possible to protect the driving circuit unit and internal components of the display device from ESD/EMI. Embodiments provide a display device that can protect a driving circuit unit and other internal components of the display device from electrostatic discharge/electromagnetic interference (ESD/EMI) by shielding the driving circuit unit.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present disclosure as set forth in the following claims.

What is claimed is:

1. A display device comprising:
a display module;
a driving circuit unit that supplies a driving signal to the display module;
a window positioned on the display module;
a first flexible circuit board having a touch sensor at one end portion thereof, wherein the one end portion is attached to the window; and
a shielding unit extended to protrude toward the driving circuit unit from the one end portion of the first flexible circuit board to shield the driving circuit unit.

2. The display device as claimed in claim 1, wherein the shielding unit covers a side surface of the driving circuit unit.

3. The display device as claimed in claim 2, wherein the shielding unit has a quadrangular box shape having an opened bottom surface or opened top and bottom surfaces.

4. The display device as claimed in claim 1, wherein the shielding unit includes a material having conductivity.

5. The display device as claimed in claim 4, wherein the shielding unit is electrically coupled to a ground terminal of the first flexible circuit board.

6. The display device as claimed in claim 1, wherein one side of the shielding unit is coupled to the first flexible circuit board, and another side of the shielding unit is adjacent to the display module on which the driving circuit unit is positioned.

7. The display device as claimed in claim 1, wherein the one end portion of the first flexible circuit board has first and second surfaces opposite to each other, and the touch sensor is positioned on the first surface, and the shielding unit is extended from the second surface.

8. The display device as claimed in claim 1, wherein the driving circuit unit is positioned in a non-display area of the display module.

9. The display device as claimed in claim 8, wherein the touch sensor is provided at a position corresponding to the non-display area of the display module.

10. The display device as claimed in claim 1, wherein the display module includes a first substrate, and a second substrate opposite to the first substrate, the second substrate being positioned more distant from the window than the first substrate, the second substrate being wider than the first substrate and including a protruding area, and the driving circuit unit being positioned on the protruding area.

11. The display device as claimed in claim 1, further comprising a second flexible circuit board configured to have one end portion electrically coupled to the driving circuit unit.

12. The display device as claimed in claim 11, wherein the second flexible circuit board is bent to surround a side of the display module, so that another end portion opposite to the one end portion of the second flexible circuit board is positioned on an opposite surface of the display module to a surface on which the driving circuit unit is positioned.

13. The display device as claimed in claim 12, wherein the first flexible circuit board is bent so that another end portion opposite to the one end portion of the first flexible circuit board is coupled to the other end portion of the second flexible circuit board.
